(19) United States
(12) Patent Application Publication
(10) Pub. No.: US 2011/0260613 A1
(43) Pub. Date: Oct. 27, 2011

(54) METAL HALIDE LAMP

(75) Inventors: Makoto Deguchi, Ehime-ken (JP); Osamu Shirakawa, Tokyo (JP)

(73) Assignee: HARISON TOSHIBA LIGHTING CORP., Imabari-shi (JP)

(21) Appl. No.: 12/674,360

(22) PCT Filed: Jun. 17, 2008
(86) PCT No.: PCT/JP08/61040

§ 371 Date: Feb. 19, 2010

(30) Foreign Application Priority Data
Aug. 21, 2007 (JP) 2007-214760

(51) Int. Cl. H01J 61/12

(52) U.S. Cl. 313/637

(57) ABSTRACT

Disclosed is a metal halide lamp, comprising an airtight tube having a discharge portion with a discharge space therein and a pair of sealing portions formed at both ends of the discharge portion; a discharge medium substantially free from mercury enclosed in the discharge space, the discharge medium including a rare gas and a metal halide, the metal halide including a scandium halide; metal foils sealed in the sealing portions; a pair of electrodes having one ends connected to the metal foils and the other ends arranged to face each other within the discharge space; and coils wound around the electrodes within the sealing portions, wherein the scandium halide has a weight ratio of not less than 30%, and the coils have an outer diameter R of not less than 0.45 mm but not more than 0.60 mm.

### TECHNICAL FIELD

The present invention relates to a metal halide lamp used for motor vehicle headlights and the like.

### BACKGROUND ART

The metal halide lamp not using mercury (hereinafter referred to as “mercury-free lamp”) is known from JP-A2005-339999 (KOKAI) (Patent Reference 1), and it has a discharge medium, which is comprised of a metal halide of sodium, scandium, zinc or the like and a rare gas such as xenon, sealed into a discharge space of an airtight tube with both ends sealed and generates a predetermined light by exciting the discharge medium by applying a voltage to electrodes connected to metal foils sealed to sealing portions.

A coil is wound around each electrode to form a space locally between the coil and the sealing portions to reduce a contact area between the electrodes and the sealing portions. Thus, a crack is prevented from being formed on the sealing portions.
Patent Reference 1: JP-A 2005-339999 (KOKAI)

### DISCLOSURE OF THE INVENTION

### Problems to be Solved by the Invention

It has been tried to seal a scandium halide in a large amount to provide a mercury-free lamp with better characteristics such as a total light flux and a lamp voltage today. But, when the scandium halide is enclosed at a weight ratio of not less than 30%, there has been a problem that even when the coil is wound around the electrodes as described above, a crack can be found at the sealing portions, causing leakage of the discharge medium, which is a so-called axial leak.

The present invention provides a metal halide lamp in which a scandium halide is enclosed at a weight ratio of not less than 30% and which can suppress the axial leak.

### Means for Solving the Problems

According to an aspect of the present invention, there is provided a metal halide lamp, comprising an airtight tube having a discharge portion with a discharge space therein and a pair of sealing portions formed at both ends of the discharge portion; a discharge medium substantially free from mercury enclosed in the discharge space, the discharge medium including a rare gas and a metal halide, the metal halide including a scandium halide; metal foils sealed in the sealing portions; a pair of electrodes having one ends connected to the metal foils and the other ends arranged to face each other within the discharge space; and coils wound around the electrodes within the sealing portions, wherein the scandium halide has a weight ratio of not less than 30%, and the coils have an outer diameter R of not less than 0.45 mm but not more than 0.60 mm.

### Effects of the Invention

The present invention provides a metal halide lamp with a scandium halide having a weight ratio of not less than 30% sealed therein, which can suppress an axial leak.

### BRIEF DESCRIPTION OF DRAWINGS

FIG. 1 is a schematic configuration view illustrating an example of the metal halide lamp of the invention.

FIG. 2 is an enlarged view showing a sealing portion and its vicinity of the metal halide lamp shown in FIG. 1.

FIG. 3 is a diagram illustrating specifications of the metal halide lamp of FIG. 1.

FIG. 4 is a diagram illustrating an axial leak occurrence rate after lighting for 2000 hours while varying a weight ratio of scandium iodide.

FIGS. 5A and 5B are diagrams showing states of electrode tip portions after lighting.

FIG. 6 is a diagram illustrating an axial leak occurrence time with an outer diameter R varied.

FIG. 7 is a graph showing a relationship between the coil outer diameter R and the axial leak occurrence time.

FIG. 8 is a graph showing a relationship between a ratio L2/L1 of an electrode length L1 and a coil-wound length L2 and an axial leak occurrence rate.

FIG. 9 is a graph showing a relationship between a ratio L2/L3 of a coil-wound length L2 and an electrode sealing length L3 and an axial leak occurrence time.

### MODE FOR CARRYING OUT THE INVENTION

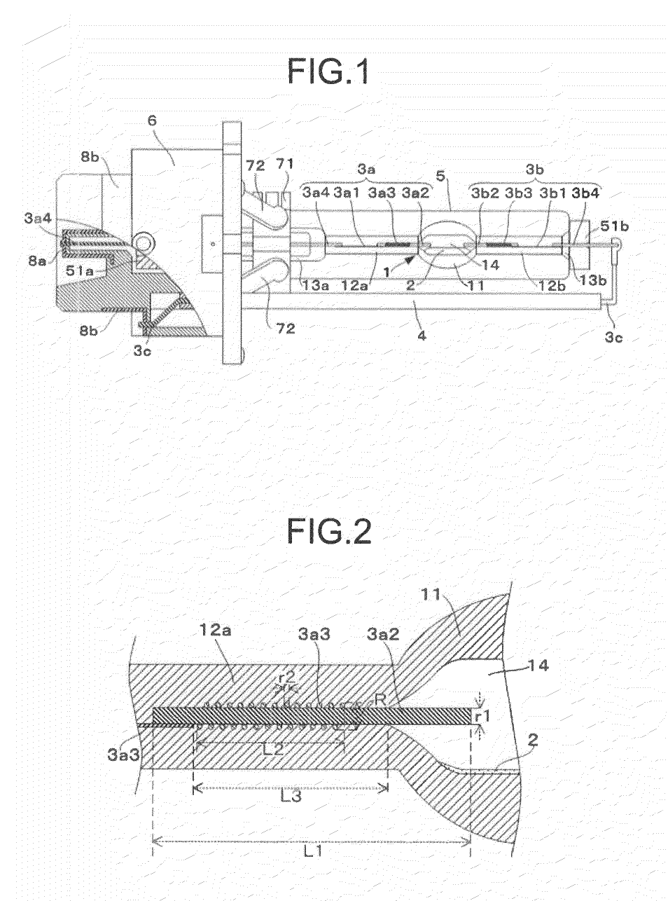

One embodiment of the metal halide lamp according to the present invention is described below with reference to the drawings. FIG. 1 is a schematic configuration view illustrating an example of the metal halide lamp of the present invention, and

FIG. 2 is an enlarged view showing a sealing portion and its vicinity of the metal halide lamp shown in FIG. 1.

As shown in FIGS. 1 and 2, the metal halide lamp of this embodiment has an airtight tube 1 made of material having heat resistance and translucency such as quartz glass. The airtight tube 1 has an elongate shape in a lamp axial direction with an almost elliptical discharge portion 11 formed at its approximate center. Plate-like sealing portions 12a and 12b are formed at both ends of the discharge portion 11, and cylindrical non-sealing portions 13a and 13b are formed at both ends of the plate-like sealing portions.

A discharge space 14 shaped like almost cylindrical shape at the center and tapered at its both ends is formed in the axial direction within the discharge portion 11. The discharge space 14 has preferably a volume of 10 mm³ to 40 mm³ when it is used for motor vehicle headlights.

A discharge medium comprising a metal halide 2 and a rare gas is sealed in the discharge space 14. The metal halide 2 is constituted by halides of sodium (Na), scandium (Sc), zinc (Zn) and indium (In). Among them, the scandium halide is determined to have a weight ratio of not less than 30 wt % in order to increase a total light flux, a lamp voltage. But, if the scandium halide has an excessively high weight ratio, temperatures of the electrode tip portions increase excessively, so that its weight ratio is desirably not more than 50 wt %.

For the halogen to be bonded to the metal halide, iodine, bromine, chlorine or a combination of plural halogens may be used, and for example, combinations such as sodium iodide (NaI), scandium iodide (ScI₃), zinc iodide (ZnI₂), indium bromide (InBr) and the like can be used.

As the rare gas, xenon (Xe) which has high luminous efficiency just after the startup and functions mainly as a starting gas is enclosed. The xenon has a sealing pressure of not less than 10 atm at room temperature (25° C.) and more desirably not less than 13 atm. Its upper limit is not particularly determined but about 20 atm at present.

The discharge space 14 is substantially free from mercury. This “substantially free from mercury” means that mercury is not contained at all or the presence of an amount equivalent to substantially no enclosure in comparison with a conventional mercury-containing metal halide lamp, e.g., less than 2 mg/ml, or preferably not more than 1 mg of mercury, is allowed.

Electrode mounts 3a and 3b are sealed in the sealing portions 12a and 12b as shown in FIG. 1. The electrode mounts 3a and 3b comprise metal foils 3a1 and 3b1, electrodes 3a2 and 3b2, coils 3a3 and 3b3 and external lead wires 3a4 and 3b4.

For example, the metal foils 3a1 and 3b1 are thin metal plates made of molybdenum.

For example, the electrodes 3a2 and 3b2 are thoriated tungsten electrodes which have thorium oxide doped to tungsten, and their diameter r1 can be determined to be, for example, not less than 0.30 mm but not more than 0.40 mm in practical use. Their one ends are connected to the metal foils 3a1 and 3b1 within the sealing portions 12a and 12b, and the other ends are arranged to face each other with a prescribed interelectrode distance between them within the discharge space 14.

It is desirable that the interelectrode distance is 4.1 mm to 4.5 mm in appearance (actual distance of 3.5 mm to 3.9 mm).

For example, the coils 3a3 and 3b3 are made of doped tungsten and wound in a spiral shape around the shaft portions of the electrodes 3a2 and 3b2 which are sealed in the sealing portions 12a and 12b. But, the coils 3a3 and 3b3 are not wound around parts of the shaft portions of the electrodes 3a2 and 3b2 which are connected with the metal foils 3a1 and 3b1, but wound around from almost the foil ends toward the discharge space 14.

The coil pitch is desirably not less than 150% but not more than 300%. The coil may have a diameter r2 of not less than 0.04 mm but not more than 0.12 mm, and it is desirable that the electrode diameter r1 and the coil diameter r2 satisfy a relationship of 0.15≦r2/r1≦0.30 in view of matching with the electrode axis.

It is necessary that the coils 3a3 and 3b3 have an outer diameter R (nearly equal to electrode diameter r1 plus coil diameter r2×2) of not less than 0.45 mm but not more than 0.60 mm, and preferably not less than 0.50 mm but not more than 0.60 mm.

As described below specifically, it is considered because the temperatures of the mutually opposed ends of the electrodes 3a2 and 3b2 become low to decrease their melting degrees so as to separate an arc spot-forming portion from the sealing portions 12a and 12b, and a degree of thermal influence of the arc spot that the sealing portions 12a and 12b receive decreases.

To suppress a chromaticity change and to enhance the reproducibility and stability of the effects of the present invention, it is desirable that an electrode length L1 and a coil-wound length L2 satisfy a relationship of 0.37≦L2/L1≦0.47. In addition, it is desirable that the coil-wound length L2 and an electrode sealing length L3 satisfy a relationship of 0.50≦L2/L3≦0.90. The above results are derived from the experimental fact as described below.

For example, the external lead wires 3a4 and 3b4 are made of molybdenum and connected to the ends of the metal foils 3a1 and 3b1 on the side opposite to the discharge portion 11 by welding. The other ends of the external lead wires 3a4 and 3b4 are extended to the exterior of the sealing portions 12a and 12b along the tube axis. One end of an L-shape support wire 3c made of nickel is connected to the lead wire 3b4 which is extended toward the front end. The other end of the support wire 3c is extended toward a socket 6 described later, and its part parallel to the tube axis is covered by a sleeve 4 made of ceramics.

A cylindrical outer tube 5, which has an oxide of titanium, cerium, aluminum or the like added to a quartz glass, is disposed concentrically with the above-configured airtight tube 1 along the tube axis to cover the exterior of the airtight tube 1. They are connected by melting the cylindrical non-sealing portions 13a and 13b at both ends of the airtight tube 1 and both ends of the outer tube 5. For example, one or a mixture of nitrogen and a rare gas such as neon, argon, xenon or the like can be sealed under a pressure of 0.05 atm to 0.3 atm in the space between the airtight tube 1 and the outer tube 5.

The socket 6 is connected to the side of the non-sealing portion 13a of the outer tube 5 which covers the airtight tube 1 therein. They are connected by pinching a metal band 71, which is fitted to the outer circumferential surface of the outer tube near the non-sealing portion 13a, with four metal tongue-shaped pieces 72 (two of them are shown in FIG. 1) which are formed at an open end of the socket 6 on the airtight tube 1 holding side. For further reinforcement of the connection, the contacted points of the metal band 71 and the tongue-shaped pieces 72 are welded by laser.

The socket 6 has a bottom terminal 8a on its bottom and a side terminal 8b on its side, and they are respectively connected with the lead wire 3a4 and the support wire 3c.

A lighting circuit is connected to the bottom terminal 8a and the side terminal 8b of the lamp configured as described above, and the lamp is lit in a horizontal state with electric power of about 35 W at a stable time and about 75 W which is not less than two times the electric power at the time of starting up.

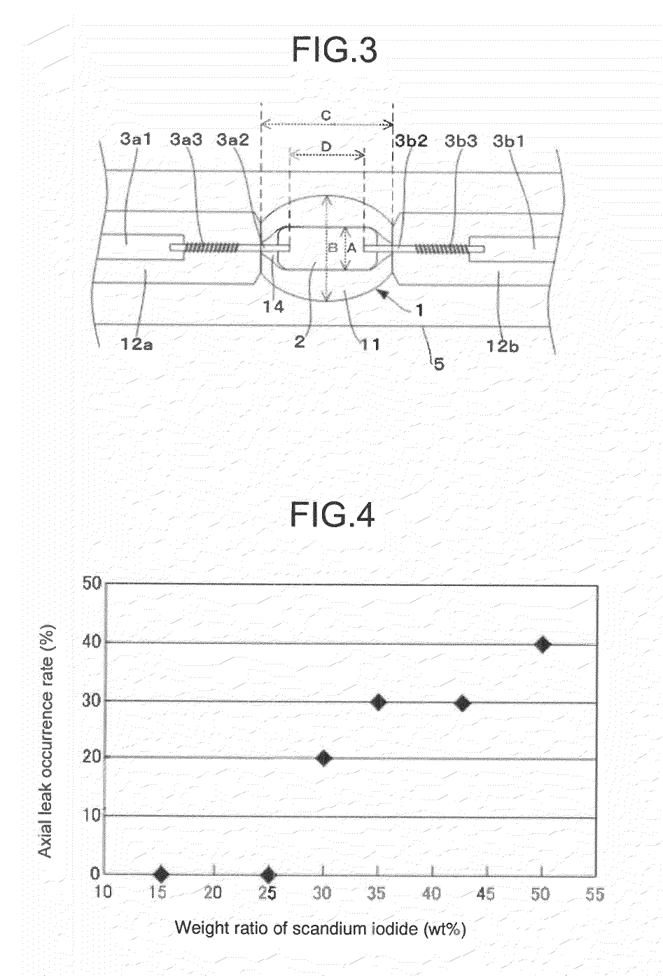

FIG. 3 is a diagram illustrating specifications of the metal halide lamp of FIG. 1. The following test is performed with the size and materials according to the same specifications unless otherwise specified.

Electric discharge tube 1: Made of quartz glass, and the discharge space 14 has an inner volume of 27 mm³, inner diameter A of 2.5 mm, outer diameter B of 6.2 mm, and sphere length C in longitudinal direction of 7.8 mm;

Metal halide 2: ScI₃—NaI—ZnI₂—InBr=0.04 mg (including ScI₃ of 35 wt %);
Rare gas: xenon=13 atm;

### Mercury: 0 mg;

Metal foils 3a1 and 3b1: Made of molybdenum;
Electrodes 3a2 and 3b2: Made of thoriated tungsten, diameter r1=0.38 mm, electrode length L1=7.5 mm, sealing length L3=4.65 mm, interelectrode distance D=3.75 mm; Coils 3a3 and 3b3: Made of doped tungsten, diameter r2=0.06 mm, coil pitch=200%, coil-wound length L2=3.2 mm, outer diameter R=0.50 mm, L2/L1=0.427, and L2/L3=0.688.

FIG. 4 is a diagram illustrating an axial leak occurrence rate after lighting for 2000 hours while varying a weight ratio of scandium iodide. Quantities of test lamps are ten for each of the weight ratio, and the test condition includes the blink cycles in the EU 120-minute mode provided in JEL215 which is a standard of an automobile headlight HID light source. In the test, the outer diameter R is 0.42 mm (diameter r1=0.30 mm, diameter r2=0.06 mm).

It is seen from FIG. 4 that when the weight ratio of the scandium iodide increases, and particularly to not less than 30 wt %, the axial leak tends to occur. Scandium halide other than the iodides shows the same tendency. It is considered melting of the electrode tip portions is relevant.

FIGS. 5A and 5B are diagrams showing states of the electrode tip portions after lighting. The electrode tip portions having a scandium halide at a weight ratio of 25 wt % are not melted so much as shown in FIG. 5A, but the electrode tip portions having the same at a weight ratio of 45 wt % are melted considerably as shown in FIG. 5B. When the electrode tip portions are melted as shown in FIG. 5B, an axial leak tends to occur because the positions where arc spots 9a and 9b are formed are displaced toward the sealing portions 12a and 12b, and the temperatures of the electrodes 3a2 and 3b2 sealed by glass increase. In other words, it is desirable that the enclosed amount of the scandium halide is small in the viewpoint of suppressing the axial leak.

Meanwhile, when the weight ratio of the scandium iodide is changed, for example, from 25 wt % to 45 wt %, a total light flux can be increased by about 50 μm, and the lamp voltage can be increased by about 5V. In other words, it is preferable that the scandium halide is enclosed in a large amount in the viewpoint of the improvement of the lamp characteristics. In view of the above, when a scandium halide of not less than 30 wt % is enclosed in order to improve the lamp characteristics, it is also necessary to take measures so as to suppress the axial leak.

In accordance with the above background, the present inventors considered that it is important to decrease the temperature of the electrode tip portions to suppress the melting of the electrodes and got the idea for increasing the outer diameters R of the coils 3a3 and 3b3 wound around the electrodes 3a2 and 3b2. It is known from JP-A 2001-76676 (KOKAI), WO 2006/058513 A1 and the like that the coils 3a3 and 3b3 are wound around the electrodes 3a2 and 3b2 which are sealed in the sealing portions 12a and 12b. But, they suppress the axial leak by appropriately lowering the adhesiveness between the glass and the electrode axis by the coils and do not teach that the coil outer diameter R is increased in order to lower the temperatures of the electrode tip portions.

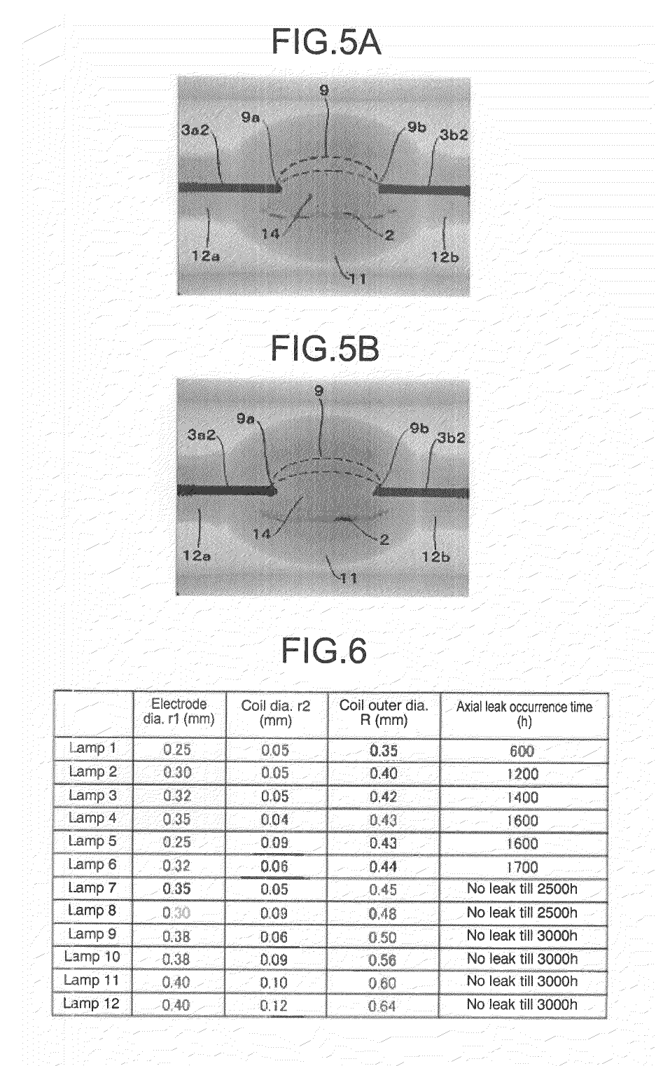

FIG. 6 is a diagram illustrating an axial leak occurrence time when the outer diameter R is varied. The axial leak occurrence time means time when an axial leak is observed for the first time in any one of the ten lamps. It is apparent from FIG. 6 that there is a tendency that the axial leak does not occur easily as the coil outer diameter R becomes larger. Specifically, it is seen that when the electrodes 3a2 and 3b2 have a diameter r1 of not less than 0.30 mm but not more than 0.40 mm and the coils 3a3 and 3b3 have an outer diameter R of not less than 0.45 mm, the axial leak does not occur easily.

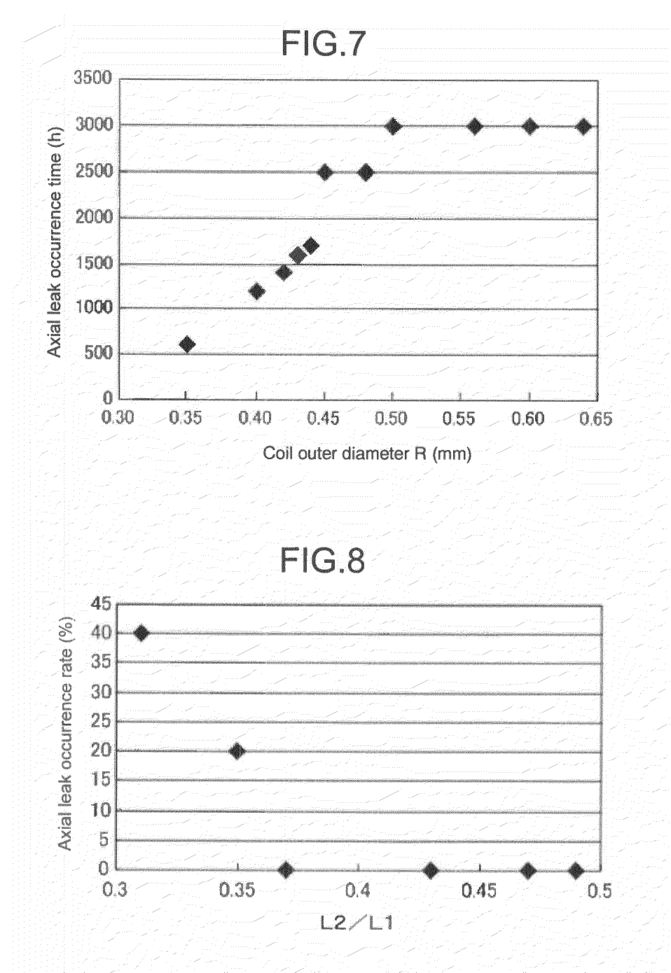

FIG. 7 is a graph showing a relationship between the coil outer diameter R and the axial leak occurrence time. It is seen from FIG. 7 that when the coil outer diameter R is not less than 0.45 mm, the axial leak suppressing effect becomes particularly high, and the occurrence of the axial leak can be suppressed in 2500 hours or more. In addition, when the coil outer diameter R is not less than 0.50 mm, the occurrence of the axial leak can be suppressed in 3000 hours or more. Therefore, it is desired that the coil outer diameter R is not less than 0.45 mm, and more desirably not less than 0.50 mm.

But, when the coil outer diameter R becomes large, the metal halide 2 is more likely to move into the sealing portions along the electrode axis, and a chromaticity change in the service life becomes large. For example, when the coil outer diameter R is larger than 0.60 mm, the chromaticity after lighting for 1000 hours changes by −0.02 at chromaticity x, and about −0.02 at chromaticity y in comparison with the time of initial light up, resulting in a color change which is apparent visually. Therefore, the coil outer diameter R is desirably not more than 0.60 mm.

The reproducibility and stability of the effects described above can be enhanced by suitably designing the electrode length L1, the coil-wound length L2 and the electrode sealing length L3. In other words, even when the coil outer diameter R is not less than 0.45 mm but not more than 0.60 mm, the effect of lowering the temperature of the electrode tip portions becomes low depending on the balance between the electrode length and the coil-wound length, and the desired effect might not be achieved.

FIG. 8 is a graph showing a relationship between a ratio L2/L1 of the electrode length L1 and the coil-wound length L2 and an axial leak occurrence rate. It is apparent from FIG. 8 that when L2/L1 becomes large, the axial leak occurrence rate decreases. But, when L2/L1 is excessively large, there is a tendency that the chromaticity change in the service life becomes larger. Therefore, it is desirable to be 0.37≦L2/L1≦0.47.

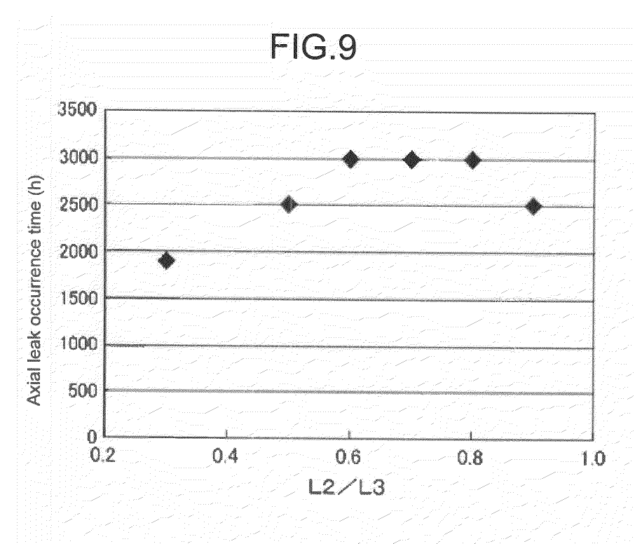

FIG. 9 is a graph showing a relationship between a ratio L2/L3 of the coil-wound length L2 and the electrode sealing length L3 and an axial leak occurrence time. It is apparent from FIG. 9 that L2/L3 is preferably large from the viewpoint of the axial leak occurrence time. But, when L2/L3 is excessively large, the chromaticity change in the service life has a tendency to become larger in a similar manner. Therefore, the ratio is desirably 0.50≦L2/L3≦0.90, and more desirably 0.60≦L2/L3≦0.80.

From the similar viewpoint, the coil pitch is desirably determined to be not less than 150% but not more than 300%.

Therefore, even when the metal halide lamp has a scandium halide at a weight ratio of not less than 30% in the metal halide 2 in this embodiment, the lamp characteristics such as a total light flux and a lamp voltage can be improved by satisfying 0.45≦R≦0.60 for the outer diameter R (mm) of the coils 3a3 and 3b3, while the axial leak occurrence associated with the enclosure of a large amount of a scandium halide is suppressed.

By configuring to satisfy that the relationship of L2/L1 between the electrode length L1 and the coil-wound length L2 is 0.37≦L2/L1≦0.47 and the relationship of L2/L3 between the coil-wound length L2 and the electrode sealing length L3 is 0.50≦L2/L3≦0.90, the reproducibility and stability of the above effects can be enhanced. And, the coil pitch is desirably determined to be not less than 150% but not more than 300%.

Although the present invention has been described in detail above by reference to the specific embodiment of the invention, the invention is not limited to the embodiment described above. It is to be understood that modifications and variations of the embodiment can be made without departing from the spirit and scope of the invention.

1. A metal halide lamp, comprising:
an airtight tube having a discharge portion with a discharge space therein and a pair of sealing portions formed at both ends of the discharge portion;
a discharge medium substantially free from mercury enclosed in the discharge space, the discharge medium including a rare gas and a metal halide, the metal halide including a scandium halide;
metal foils sealed in the sealing portions;
a pair of electrodes having one ends connected to the metal foils and the other ends arranged to face each other within the discharge space; and
coils wound around the electrodes within the sealing portions,
wherein the scandium halide has a weight ratio of not less than 30%, and the coils have an outer diameter R of not less than 0.45 mm but not more than 0.60 mm.

2. The metal halide lamp according to claim 1, wherein the coils have an outer diameter R of not less than 0.50 mm but not more than 0.60 mm.

3. The metal halide lamp according to claim 1,
wherein the electrodes have a diameter r1 of not less than 0.30 mm but not more than 0.40 mm.

4. The metal halide lamp according to claim 1,
wherein when it is assumed that the electrodes have a length L1 and the coils have a wound length L2, a relationship of 0.37≦L2/L1≦0.47 is satisfied.

5. The metal halide lamp according to claim 1,
wherein when it is assumed that the coils have the wound length L2 and the electrodes have a sealing length L3, a relationship of 0.50≦L2/L3≦0.90 is satisfied.

6. The metal halide lamp according to claim 1,
wherein the coils have a pitch of not less than 150% but not more than 300%.
